(19) United States
(12) Patent Application Publication
(10) Pub. No.: US 2025/0029805 A1
(43) Pub. Date: Jan. 23, 2025

(54) LATCHING MODULE FOR ELECTRICAL DEVICE AND CONTACTOR COMPRISING THE LATCHING MODULE

(71) Applicant: Schneider Electric Industries SAS, Rueil-Malmaison (FR)

(72) Inventors: Shaofan Li, Shanghai (CN); Yanhong Ma, Shanghai (CN); Yuanzhong Wang, Shanghai (CN); Juan Xie, Shanghai (CN)

(73) Assignee: Schneider Electric Industries SAS, Rueil-Malmaison (FR)

(21) Appl. No.: 18/761,914

(22) Filed: Jul. 2, 2024

(30) Foreign Application Priority Data
Jul. 19, 2023 (CN) 202321908837.7

(51) Int. Cl. H01H 71/50; H01H 71/12; H01H 71/24

(52) U.S. Cl. CPC H01H 71/505; H01H 71/128; H01H 71/24

(57) ABSTRACT

A latching module for an electrical device includes: a swing arm movable between an unlocked position and a locked position; a tripper movable between a holding position and a tripped position; a holder, its first portion acts on the tripper and its second portion acts on the swing arm. When the swing arm is in the locked position and the tripper is in the holding position, the holder bears a force from the swing arm to make the holder abut against the tripper to apply a force on the tripper, and the tripper is secured in the holding position, and the holder holds the swing arm in the locked position. When the tripper is in the tripped position, the holder releases the hold on the swing arm and the swing arm moves from the locked position towards the unlocked position. A contactor including the latching module also is disclosed.

### TECHNICAL FIELD

The present disclosure relates to a latching module for an electrical device and a contactor comprising the latching module.

### BACKGROUND

In the electrical field, latching modules are required for many electrical devices including, for example, contactors, relays, switches, and the like. In general, electrical devices contain moving components (contact of a contactor belong this kind of parts), which need to be switched between different states, and often require the moving components to be locked in one state and switched to another state when needed.

Taking a contactor as an example, the contact of which are brought into closed state when energized under the drive of the contact swing arm, and should remain in the closed state until the contact are opened after de-energization. In conventional contactors, the closed state of the contact is typically kept by continuously power supply. This close-state maintaining mechanism is then power consumption and has poor reliability. In another approach, additional latching modules are typically added to the contactor to realize the states switching of the contact. The latching module typically includes a swing arm that is indirectly coupled to the contact swing arm of the contactor, and locking and unlocking of the swing arm is typically accomplished by engagement between teeth at the end of the swing arm in the latching module and teeth on the holder. In this configuration, however, due to limitations in the positional relationship and dimensional configuration between the teeth, the locking force cannot be significantly increased, which greatly affects the shock resistance of the latching module, and poor shock resistance may lead to false tripping of the latching module. However, increasing the latching force simultaneously increases the tripping force of the latching module, resulting in the latching module not operating properly under low voltage.

Therefore, there is a need in the art for a latching module that can lock a moving component in one state in a simple and reliable manner and switch the moving component to another state in a simple and reliable manner.

### SUMMARY

In view of the above-mentioned problems and needs, the present disclosure proposes a novel technical solution, which solves the above-mentioned problems due to adopting the following technical features, and brings about other technical effects.

The present disclosure provides a latching module for an electrical device, comprising: a swing arm movable between an unlocked position and a locked position; a tripper movable in a first direction towards a holding position or in a second direction towards a tripped position, the first direction being opposite to the second direction; a holder, a first portion of which can act on the tripper and a second portion of which can act on the swing arm; wherein, when the swing arm is in the locked position and the tripper is in the holding position, the holder bears a force applied by the swing arm to make the holder abut against the tripper to apply a force on the tripper in the first direction, such that the tripper is secured in the holding position, and the holder holds the swing arm in the locked position; when the tripper is in the tripped position, the holder releases the hold on the swing arm so that the swing arm can be moved from the locked position towards the unlocked position.

Preferably, the tripper is provided as a pivotable tripper, which can pivot in a first direction towards the holding position or pivot in a second direction towards the tripped position.

Preferably, the pivotable tripper comprises a pivot portion, a first portion and a second portion both extending from the pivot portion, wherein the first portion of the holder acts on the second portion, and wherein the first portion is held on a fixed portion or component of the latching module when the tripper is in the holding position, to keep the tripper fixed in the holding position.

Preferably, the latching module further comprise a driver coupled with the tripper to drive the tripper from the holding position to the tripped position.

Preferably, the driver comprises a coil and a moving iron core arranged inside the coil, with one end of the moving iron core connected to the tripper to drive the tripper from the holding position to the tripped position by means of the moving iron core when the coil is energized.

Preferably, the latching module further comprise a return spring disposed between the moving iron core and a fixed portion or component of the latching module to resiliently bias the moving iron core to apply a force on the tripper in the first direction through the moving iron core.

Preferably, the tripper further comprises a manual operation portion, the end of which extends outside the housing of the latching module.

Preferably, the holder is arranged as a pivotable holder that pivots about a pivot portion.

Preferably, the pivotable holder is provided as a frame-type component comprising a window portion, wherein the positional relationship between the swing arm and the pivotable holder is set such that: the tip of the swing arm pushes the inner side of the lower edge of the window portion to pivot the pivotable holder, during the movement of the swing arm from the unlocked position to the locked position; when the swing arm is in the locked position, the tip of the swing arm abuts against the outer-side of the lower edge of the window portion, said lower edge being located at the second portion.

Preferably, the latching module according to claim 1 further comprises a linkage coupled with the swing arm to drive the swing arm between the locked and unlocked positions.

Preferably, the linkage comprises a first feature arranged to drive the tripper in the second direction during the movement of the swing arm towards the locked position driven by the linkage.

Preferably, the first feature is provided as a bump formed on the linkage and the tripper comprises a toggle extending from the tripper, wherein during the movement of the swing arm towards the locked position, the toggle is toggled by the bump, such that the tripper is moved in the second direction.

Preferably, the linkage comprises a rack and the swing arm is arranged pivotably movable and comprises a pivot end and a tip opposite to the pivot end, wherein the swing arm comprises gear teeth arranged around the pivot end and meshing with the rack.

Preferably, the linkage comprises an engagement portion to engage with a related engagement portion of a moving component of an electrical device, so that the swing arm is coupled with the moving component of the electrical device through the linkage.

Preferably, the electrical device is a contactor, the moving component of the electrical device is a contact swing arm for a contact of the contactor, the linkage of the latching module being connected with a linkage in the contactor connected to the contact swing arm.

Preferably, the latching module further comprises a return spring, wherein: the return spring resiliently biases the tripper in a first direction; or the return spring resiliently biases the holder so that a force in the first direction is applied to the tripper by the holder.

The disclosure also provides a contactor comprising a latching module described above, the swing arm of the latching module being coupled with a contact swing arm for a contact of a contactor to lock the contact in the closed position when the swing arm is held in the locked position by the holder.

According to the present disclosure, the force acting on the swing arm from the moving component of the electric device can be bore by stronger members such as the holder and the tripper, so that the locking force of the entire latching module can be significantly increased, and the shock resistance can be improved without significantly increasing the tripping force of the tripper, and even the tripping force can be further reduced with respect to the latching module of the prior art, so that the latching module can be smoothly tripped at a low pressure.

### BRIEF DESCRIPTION OF DRAWINGS

FIG. 1 shows an exploded view of a latching module according to a preferred embodiment of the present disclosure;

FIG. 2 shows a perspective view and a plan view of an unlocked state of the latching module;

FIG. 3 shows a perspective view and a plan view of a locked state of the latching module, and the plan view is a sectional view taken from the middle of the holder 3;

FIGS. 4-5 are schematic diagrams of a latching module according to a preferred embodiment of the present disclosure, with FIG. 4 showing an unlocked state of the latching module and FIG. 5 showing a locked state of the latching module.

### DETAILED DESCRIPTION

In order to make the purpose, technical solution and advantages of the technical solution of the present disclosure clearer, the technical solution of the embodiment of the present disclosure will be described clearly and completely in the following with the attached drawings of specific embodiments of the present disclosure. Like reference numerals in the drawings represent like components. It should be noted that a described embodiment is a part of the embodiments of the present disclosure, not the whole embodiments. Based on the described embodiments of the present disclosure, all other embodiments obtained by those skilled in the field without creative labor fall into the scope of protection of the present disclosure.

In comparison with the embodiments shown in the attached drawings, feasible embodiments within the protection scope of the present disclosure may have fewer components, other components not shown in the attached drawings, different components, components arranged differently or components connected differently, etc. Furthermore, two or more components in the drawings may be implemented in a single component, or a single component shown in the drawings may be implemented as a plurality of separate components.

Unless otherwise defined, technical terms or scientific terms used herein shall have their ordinary meanings as understood by those skilled in the field to which this disclosure belongs. The terms “first”, “second” and similar terms used in the specification and claims of the patent application of this disclosure do not indicate any order, quantity or importance, but are only used to distinguish different components. When the number of components is not specified, the number of components can be one or more. Similarly, terms such as “a/an”, “the” and “said” do not necessarily mean quantity limitation. Similar terms such as “including” or “comprising” mean that the elements or objects appearing before the terms cover the elements or objects listed after the terms and their equivalents, without excluding other elements or objects. Similar terms such as “installation”, “setting”, “connection” or “coupling” are not limited to physical or mechanical installation, setting and connection, but can include electrical installation, setting and connection, whether directly or indirectly. “up”, “down”, “left” and “right” are only used to indicate the relative orientation relationship when the equipment is used or the orientation relationship shown in the attached drawings. When the absolute position of the described object changes, the relative orientation relationship may also change accordingly. For ease of description, the term “in/inwardly” means toward the interior of the relevant structure, and conversely, the term “out/outwardly” means toward the exterior of the relevant structure. In addition, the same reference numerals may be used in different embodiments to refer to components having the same or similar structure and functionality.

The present disclosure provides a latching module for an electrical device. Hereinafter, the disclosure will be described with a contactor as an example of the electrical device and with a contact swing arm for a contact of the contactor as an example of the moving component. In this case, the latching module according to the present disclosure is used for realizing locked-closing and releasing of the contact of the contactor.

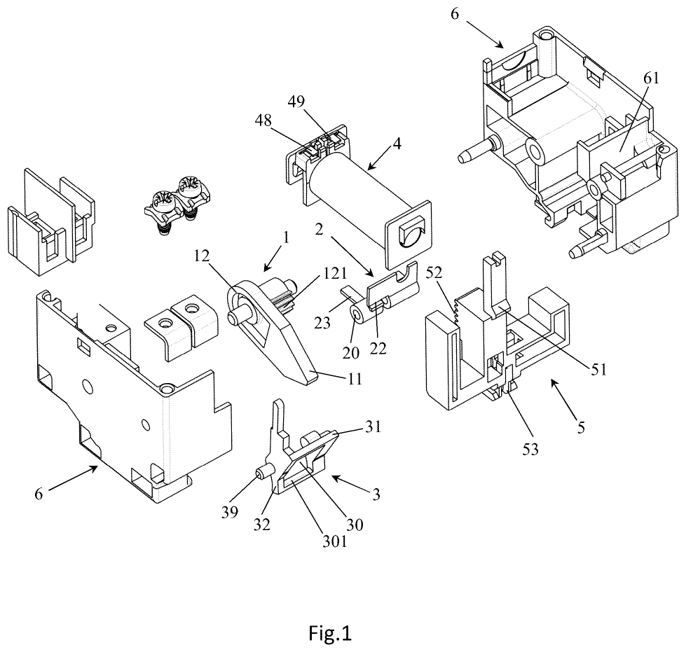

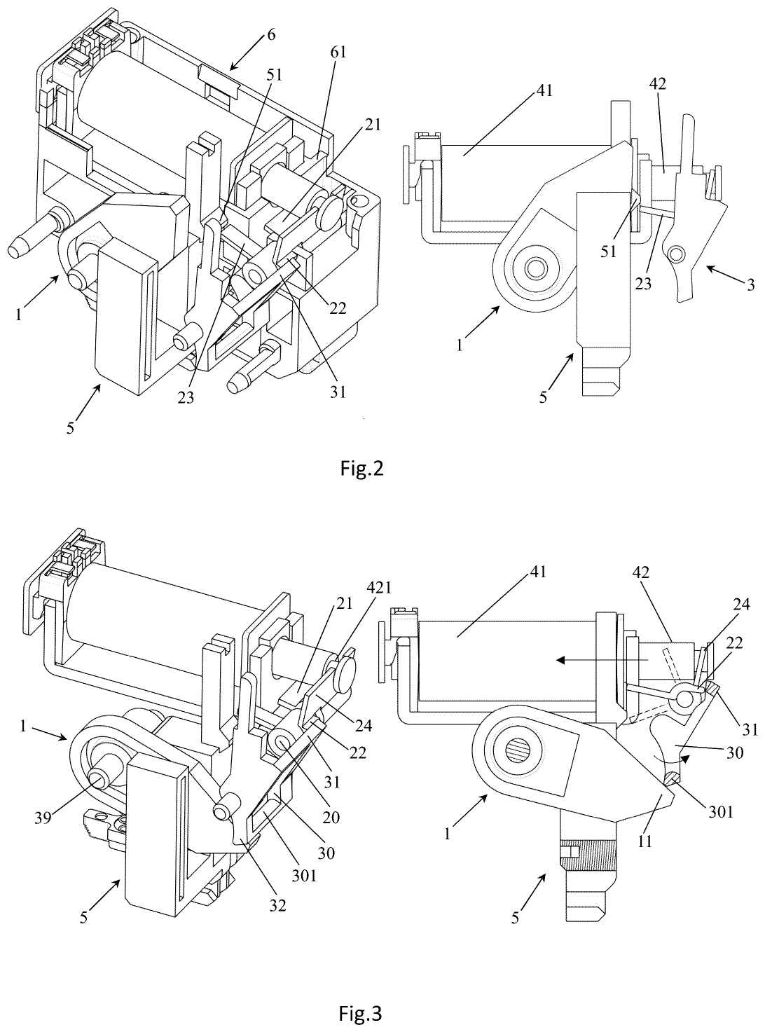

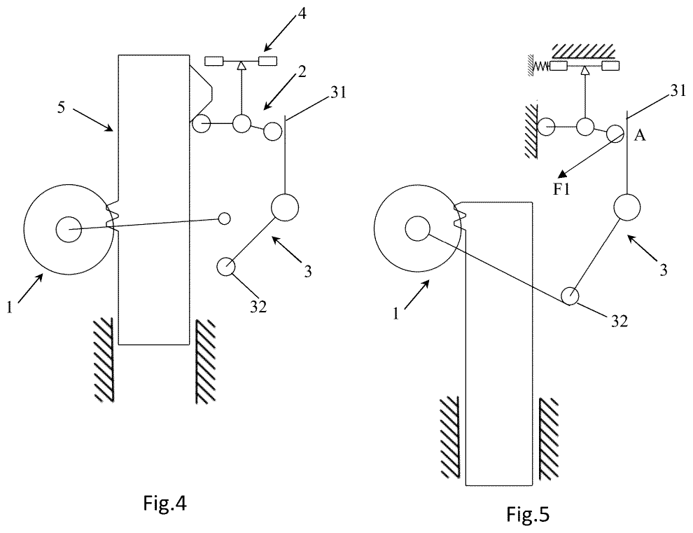

Referring to FIGS. 1-5, wherein FIG. 1 shows an exploded view of a latching module according to a preferred embodiment of the present disclosure; FIG. 2 shows a perspective view and a plan view of an unlocked state of the latching module (the housing 6 is removed from the plan view of FIG. 2 for ease of illustration); FIG. 3 shows a perspective view and a plan view of a locked state of the latching module, with the housing 6 removed in FIG. 3 for ease of illustration, and the plan is a sectional view taken through the middle of the holder 3; FIGS. 4-5 are schematic diagrams of the latching module according to the preferred embodiment of the present disclosure, with FIG. 4 showing the unlocked state of the latching module and FIG. 5 showing the locked state of the latching module.

Referring to the schematics of FIGS. 4-5, the latching module comprises: a swing arm 1, a tripper 2, and a holder 3. In particular, the swing arm 1 is movable between an unlocked position (as shown in FIG. 4) and a locked position (as shown in FIG. 5). Taking a contactor as an example, the swing arm 1 may be directly connected or indirectly connected by any suitable means to a contact swing arm for a contact of the contactor (the contact swing arm is a driving means to realize switching of the contact between the closed state and open state), so that the movement of the contact swing arm moves the swing arm 1 together, that is, when the contact moves to the closed position, the swing arm moves to the locked position, and when the contact moves to the open position, the swing arm moves to the released position; and when the swing arm 1 is held in the locked position, the contact is also locked in the closed state.

The tripper 2 is movable in a first direction towards a holding position or in a second direction towards the tripped position, and the first direction is opposite to the second direction.

A first portion 31 of the holder 3 can act on the tripper 2 and a second portion 32 can act on the swing arm 1.

According to the principles of the present disclosure, when the swing arm 1 is in the locked position and the tripper 2 is in the holding position, the holder 3 bears a force applied by the swing arm 1 to make the holder 3 abut against the tripper 2 to apply a force on the tripper in the first direction, such that the tripper 2 is secured in the holding position so as to have a tendency to move in the first direction, the holder 3 holds the swing arm 1 in the locked position.

Specifically, with further reference to the schematic diagram of FIG. 5 showing a state in which the swing arm 1 is in the locked position and the tripper 2 is in the holding position. The holding position is the extreme movement position of the tripper 2. The swing arm 1 applies a force on the second portion 32 of the holder 3 at point A. As a result of this force at point A, the holder 3 further applies a force F1 on the tripper 2 at point A, and the force F1 has a tendency to move the tripper 2 in the first direction. Therefore, the tripper 2 is further secured in the holding position and the holder 3 cannot push the tripper 2 further, since the holding position is already the extreme movement position of the tripper 2. In this way, both the tripper 2 and the holder 3 are kept in the state shown in FIG. 5, thereby also keeping the swing arm 1 in the locked position, i.e. keeping the contact of the contactor in the closed state.

As previously mentioned, the holding position of the tripper 2 is its extreme movement position, which may be defined, for example, by corresponding components or portions on the housing of the latching module, or by corresponding structural features on the tripper 2, which will not be described detailedly.

On the other hand, when the tripper 2 is in the tripped position (e.g. after being driven by the driver 4 hereinafter), the holder 3 releases its hold on the swing arm 1 so that the swing arm 1 can be moved from the locked position towards the unlocked position. Specifically, after movement of the tripper 2 in the second direction to the tripped position, the tripper 2 is moved away from the holder 3, the holder 3 is free to move, and the holder 3 no longer applies a holding action on the swing arm 1, such that the swing arm 1 can overcome the frictional force on the interface therebetween and push the holder 3 away, to move from the locked position to the unlocked position. The principles of the disclosure will be further described hereinafter in connection with preferred embodiments in the disclosure.

In addition, those skilled in the art will appreciate that, after understanding the principles of the present disclosure, various implementations of the above-described components of the present disclosure can be made in accordance with the principles, as long as they can achieve the above-described interaction relationship between the components to achieve locking and unlocking, without departing from the scope of the present disclosure.

Referring to the preferred embodiment shown in FIGS. 1-3, the swing arm 1 is preferably provided as a pivotable component, e.g. the swing arm 1 is pivotable clockwise from the unlocked position shown in FIGS. 2 and 4 to the locked position shown in FIGS. 3 and 5. Of course, the swing arm may also be provided as a translatable member, as long as it is movable between the unlocked position and the locked position and acts with the holder in the above-described interactive relationship.

In the preferred embodiment shown in FIGS. 1-3, the tripper 2 is preferably configured as a pivotable tripper such that it can pivot in a first direction towards the holding position or pivot in a second direction towards the tripped position. Accordingly, the first direction is a clockwise direction in FIGS. 2-5 and the second direction is a counterclockwise direction in FIGS. 2-5. Movement of the tripper 2 between the holding position and the tripped position may be achieved by a driver 4 as described later, or may be achieved by any other suitable means, for example, manually.

Specifically, the pivotable tripper 2 may include a pivot portion 20, and a first portion 21 and a second portion 22 both extending from the pivot portion 20. The first portion 21 and the second portion 22 preferably extend at an angle to each other. The first portion 31 of the holder 3 may act on the second portion 22, and the first portion 21 is kept on a fixed portion or component of the latching module when the tripper 2 is in the holding position, to keep the tripper 2 secured in the holding position.

The fixed portion or component as previously described may be a housing, a frame or other relatively stationary portion or component of the latching module. For example, referring to FIGS. 1 and 2, the housing 6 may include an upstanding wall 61 as the fixed portion. With this construction, on the one hand, when the tripper 2 is in the holding position (that is, when the swing arm 1 is in the locked position), the first portion 21 of the tripper 2 can be kept in the holding position by the frictional force between it and the upstanding wall 61, without moving in the second direction when not driven by an external force; on the other hand, when the tripper 2 is driven in the second direction, the tripper 2 will overcome the frictional force and move to the tripped position (see the tripper condition shown in phantom in FIG. 3). Of course, instead of relying on such frictional force to keep the holding position of the tripper 2, this effect may be achieved in other suitable ways, for example a resilient bump may be provided on the upstanding wall 61, and when the tripper 2 is driven towards the tripped position, the tripper 2 may overcome the resilient force of the resilient bump and press it backward, and then move to the tripped position.

After learning the above principles, the tripper may also be provided as a translatable member as long as it is movable between the holding position and the tripped position and interacts with the holder as described above.

Preferably, the latching module may further comprise a driver 4 coupled with the tripper 2 to drive the tripper 2 from the holding position to the tripped position.

According to a preferred embodiment illustrated in FIGS. 1-3, the driver 4 may comprise a coil 41 and a moving iron core 42 arranged inside the coil 41, with one end of the moving iron core 42 connected to the tripper 2, to drive the tripper 2 from the holding position to the tripped position by means of the moving iron core 42 when the coil 41 is energized. For example, coil 41 may be energized through terminals 48, 49 in accordance with an external tripping signal.

With particular reference to FIG. 3, the moving iron core 42 may be provided as a cylindrical moving iron core with an annular groove 421 at one end, and the tripper 2 comprises a wall surface 24 having a notched portion insertable into the annular groove 421. Thus, after the coil 41 is energized, the moving iron core 42 is driven by the electromagnetic force and moves to the left along the horizontal arrow in the plan view of FIG. 3, to move the wall surface 24 and thus the tripper 2, i.e., move in the first direction (counterclockwise), to realize the movement of the tripper 2 from the holding position to the tripped position. The dashed line in FIG. 3 shows the state of the tripper 2 after driven by the iron core 42 to the left, which also means that the tripper 2 has been moved to the tripped position so that the holder 3 is free to move (i.e. can move along the counterclockwise arrow in FIG. 3) and, further, the holder 3 is moved away from the swing arm 1 and its holding action on the swing arm 1 is released.

It will be appreciated that the driving force of the driver 4 is set to be sufficient to overcome the holding force (e.g. frictional force) between the first portion 21 of the tripper and the fixed portion or component (e.g. upstanding wall 61) of the latching module, and this driving force has a wide range of adjustment compared with the prior art.

Of course, it should also be understood that the driver 4 may be a motor that may directly drive the tripper 2 (e.g., the motor shaft coupled to the pivot portion of the tripper), or indirectly drive the tripper 2 through any suitable intermediate mechanism or component; the driver 4 may be any other form of device or component as long as it is capable of realizing the above-described movement of the tripper 2 as desired.

Preferably, the latching module may further comprise a return spring (not shown) which may be disposed between the moving iron core 42 and a fixed portion or component of the latching module, to resiliently bias the moving iron core 42 so as to apply a force on the tripper 2 in the first direction through the moving iron core 42, so that the tripper 2 has a tendency to move in the first direction, so that after de-energization of the coil 42, the return spring will urge the tripper 2 back to the holding position through the moving iron core 42. For example, the return spring may be connected at one end to the tail portion of the moving iron core 42 (the tail portion is opposite to the end having the annular groove 421 and connected to the tripper 2) and at the other end to the housing 42. It will be appreciated that the return spring may be provided in any suitable position by any suitable means.

Preferably, the tripper 2 may further comprise a manual operating portion (not shown), the end of which extends outside the housing 6 of the latching module, so that the tripper 2 may be tripped when desired by toggling the manual operating portion (e.g., to the left along the horizontal arrow of FIG. 3), hold on the swing arm 1 by the holder 3 is released, and thereby the locking of the contact of the contactor by the swing arm 1 is released. The manual operation portion may be, for example, a rod portion extending upwardly from the wall surface 24 and emerging from the housing 6.

Preferably, referring to FIGS. 1 and 3, the holder 3 may be provided as a pivotable holder that pivots about a pivot 39. Further, the pivotable holder is provided as a frame-type component comprising a window portion 30. According to this structure, the positional relationship between the swing arm 1 and the pivotable holder may be set such that the tip 11 of the swing arm 1 pushes the inner-side of the lower edge 301 of the window portion 30 to pivot the pivotable holder during the movement of the swing arm 1 from the unlocked position to the locked position; whereas when the swing arm 1 is in the locked position (FIG. 3), the tip 11 of the swing arm 1 abuts against the outer-side of the lower edge 301 of the window portion 30 (at a portion outside the window portion). The lower edge 301 is located at the second portion 32 of the holder 3. The inner-side of the lower edge 301 (the portion inside the window portion) is preferably formed to have an arc-shaped surface to facilitate the pushing of the swing arm 1.

Preferably, the latching module according to the disclosure may further comprise a linkage 5 coupled with the swing arm 1 to drive the swing arm 1 between the locked position and the unlocked position.

Further preferably, referring to FIGS. 1 and 2, the linkage 5 comprises a first feature 51 arranged to drive the tripper 2 in the second direction during the movement of the swing arm 1 towards the locked position driven by the linkage 5.

Further preferably, the first feature 51 may be provided as a bump formed on the linkage 5 and the tripper 2 comprises a toggle 23 extending from the tripper 2. During the movement of the swing arm 1 towards the locked position, the toggle 23 is toggled by the bump to move the tripper 2 in the second direction so that the holder 3 is not restrained by the tripper 2 and the swing arm 1 can push away the holder 3 and move to the locked position. Subsequently, the tripper 2 returns to the holding position and holds the swing arm 1 in the locked position as previously described.

Further preferably, where the swing arm 1 is provided as a pivotable component, the swing arm 1 comprises a pivot end 12 and a tip 11 opposite to the pivot end, and the linkage 5 may comprise a rack 52, and the swing arm 1 comprises gear teeth 121 arranged around the pivot end 12 and meshing with the rack 52, such that the linkage 5 may drive the swing arm 1 towards the locked position or towards the unlocked position.

Preferably, the linkage 5 comprises an engagement portion 53 to engage with a related engagement portion of a moving component of an electrical device, so that the swing arm 1 is coupled with the moving component of the electrical device through the linkage 5. Taking a contactor as an example, the contactor may include a contact swing arm (i.e., the moving component) for the contact of the contactor. Preferably, the contactor further comprises a linkage connected to the contact swing arm, the linkage may have a snap connection structure, and the engagement portion 53 of the linkage 5 of the latching module also has a corresponding snap connection structure, so that the linkage of the contact swing arm and the linkage 5 of the latching module may be connected together by the cooperation between the two snap connection structures, so that the two linkages move together, i.e. movement of the contact of the contactor from the closed position to the open position will move the linkage 5 and thus move the swing arm 1 from the locked position to the released position, and vice versa.

With this configuration, when the contact of the contactor needs to be transitioned from the closed state to the open state, the driver 4 can synchronously receive a trip signal (e.g. to energize the coil 41 in the preferred embodiment) to drive the tripper 2 to the tripped position, to release the hold on the swing arm 1, so that the swing arm 1 unlocks the contact of the contactor, and the contact of the contactor can smoothly return to the open state.

It will be appreciated that the return spring may also have other implementation according to different preferred embodiments. For example, the return spring may resiliently bias the tripper 2 in a first direction (e.g., a torsion spring mounted on the pivot portion 20 of the tripper 2) so that the tripper 2 has a tendency to move in the first direction; alternatively, the return spring may resiliently bias the holder 3 (e.g. a torsion spring mounted on the pivot portion 39 of the holder 3) so that a force in the first direction is applied to the tripper 2 by the holder 3 so that the tripper 2 has a tendency to move in the first direction. It will be appreciated that the return spring described above may be provided in any suitable position by suitable means.

Taking the contactor as an example, the conventional technical solution, which requires the continuous power supply to maintain the closed state of the contact, can be completely replaced by the present solution. Furthermore, the present solution solves the problem that the locking force cannot be increased as in the prior art latching modules. According to the present disclosure, the force acting on the swing arm from the moving component of the electric device can be taken up by stronger members such as the holder and the tripper, so that the locking force of the entire latching module can be significantly increased, and the shock resistance can be improved without significantly increasing the tripping force of the tripper, and even the tripping force can be further reduced with respect to the latching module of the prior art, so that the latching module can be smoothly tripped at a low pressure.

Finally, the present disclosure also provides a contactor comprising a latching module as previously described, the swing arm 1 of which is coupled with a contact swing arm for a contact of a contactor to lock the contact in its closed position when the swing arm 1 is held in the locked position by the holder 3. It is to be understood that “the swing arm 1 is coupled with the contact swing arm for a contact of a contactor” as referred to herein means that the swing arm 1 is directly connected with the swing arm for the contact of the contactor or indirectly connected through any suitable intermediate means, for example through a connection between a linkage of the latching module and a linkage in the contactor connected to the contact swing arm as described above, as long as linked locking and unlocking is achieved between the swing arm of the latching module and the contact swing arm.

The exemplary implementation of the present disclosure has been described in detail above with reference to the preferable embodiments. However, it can be understood by those skilled in the art that without departing from the concept of the present disclosure, various changes and modifications can be made to the above specific embodiments, and various technical features and structures provided in this disclosure can be combined in various ways without going beyond the protection scope of the present disclosure, which is determined by the appended claims.

1. A latching module for an electrical device, comprising:
a swing arm movable between an unlocked position and a locked position;
a tripper movable in a first direction towards a holding position or in a second direction towards a tripped position, the first direction being opposite to the second direction;
a holder, a first portion of which can act on the tripper and a second portion of which can act on the swing arm;
wherein, when the swing arm is in the locked position and the tripper is in the holding position, the holder bears a force applied by the swing arm to make the holder abut against the tripper to apply a force on the tripper in the first direction, such that the tripper is secured in the holding position, and the holder holds the swing arm in the locked position; when the tripper is in the tripped position, the holder releases the hold on the swing arm so that the swing arm can be moved from the locked position towards the unlocked position.

2. The latching module according to claim 1, wherein the tripper is provided as a pivotable tripper, which can pivot in a first direction towards the holding position or pivot in a second direction towards the tripped position.

3. The latching module according to claim 2, wherein the pivotable tripper comprises a pivot portion, a first portion and a second portion both extending from the pivot portion, wherein the first portion of the holder acts on the second portion, and wherein the first portion is held on a fixed portion or component of the latching module when the tripper is in the holding position, to keep the tripper fixed in the holding position.

4. The latching module according to claim 1, further comprising a driver coupled with the tripper to drive the tripper from the holding position to the tripped position.

5. The latching module according to claim 4, wherein the driver comprises a coil and a moving iron core arranged inside the coil, with one end of the moving iron core connected to the tripper to drive the tripper from the holding position to the tripped position by means of the moving iron core when the coil is energized.

6. The latching module according to claim 5, further comprising a return spring disposed between the moving iron core and a fixed portion or component of the latching module to resiliently bias the moving iron core to apply a force on the tripper in the first direction through the moving iron core.

7. The latching module according to claim 1, wherein the tripper further comprises a manual operation portion, the end of which extends outside the housing of the latching module.

8. The latching module according to claim 1, wherein the holder is arranged as a pivotable holder that pivots about a pivot portion.

9. The latching module according to claim 8, wherein the pivotable holder is provided as a frame-type component comprising a window portion, wherein the positional relationship between the swing arm and the pivotable holder is set such that:
the tip of the swing arm pushes the inner side of the lower edge of the window portion to pivot the pivotable holder, during the movement of the swing arm from the unlocked position to the locked position;
when the swing arm is in the locked position, the tip of the swing arm abuts against the outer-side of the lower edge of the window portion, said lower edge being located at the second portion.

10. The latching module according to claim 1, further comprising a linkage coupled with the swing arm to drive the swing arm between the locked and unlocked positions.

11. The latching module according to claim 10, wherein the linkage comprises a first feature arranged to drive the tripper in the second direction during the movement of the swing arm towards the locked position driven by the linkage.

12. The latching module according to claim 11, wherein the first feature is provided as a bump formed on the linkage and the tripper comprises a toggle extending from the tripper, wherein during the movement of the swing arm towards the locked position, the toggle is toggled by the bump, such that the tripper is moved in the second direction.

13. The latching module according to claim 10, wherein the linkage comprises a rack and the swing arm is arranged pivotably movable and comprises a pivot end and a tip opposite to the pivot end, wherein the swing arm comprises gear teeth arranged around the pivot end and meshing with the rack.

14. The latching module according to claim 10, wherein the linkage comprises an engagement portion to engage with a related engagement portion of a moving component of an electrical device, so that the swing arm is coupled with the moving component of the electrical device through the linkage.

15. The latching module according to claim 14, wherein the electrical device is a contactor, the moving component of the electrical device is a contact swing arm for a contact of the contactor, the linkage of the latching module being connected with a linkage in the contactor connected to the contact swing arm.

16. The latching module according to claim 1, further comprising a return spring, wherein:
the return spring resiliently biases the tripper in a first direction; or
the return spring resiliently biases the holder so that a force in the first direction is applied to the tripper by the holder.

17. A contactor comprising:
a latching module, comprising:
a swing arm movable between an unlocked position and a locked position;
a tripper movable in a first direction towards a holding position or in a second direction towards a tripped position, the first direction being opposite to the second direction;
a holder, a first portion of which can act on the tripper and a second portion of which can act on the swing arm;
wherein, when the swing arm is in the locked position and the tripper is in the holding position, the holder bears a force applied by the swing arm to make the holder abut against the tripper to apply a force on the tripper in the first direction, such that the tripper is secured in the holding position, and the holder holds the swing arm in the locked position; when the tripper is in the tripped position, the holder releases the hold on the swing arm so that the swing arm can be moved from the locked position towards the unlocked position
wherein, the swing arm of the latching module being coupled with a contact swing arm for a contact of a contactor to lock the contact in the closed position when the swing arm is held in the locked position by the holder.
